(19) United States
(12) Patent Application Publication
(10) Pub. No.: US 2021/0350705 A1
(43) Pub. Date: Nov. 11, 2021

(54) DEEP-LEARNING-BASED DRIVING ASSISTANCE SYSTEM AND METHOD THEREOF

(71) Applicant: National Chiao Tung University, Hsinchu (TW)

(72) Inventors: Jiun-In Guo, Hsinchu (TW); Chun-Yu Lai, Taoyuan (TW)

(21) Appl. No.: 17/064,698

(22) Filed: Oct. 7, 2020

(30) Foreign Application Priority Data
May 11, 2020 (TW) 109115647

(51) Int. Cl. G08G 1/16; G06K 9/00; G06K 9/46; G06K 9/62; G05D 1/02

(52) U.S. Cl. CPC G08G 1/167; G06K 9/00798; G06K 9/4638; G06K 9/6232; G05D 2201/0213; G05D 1/0221; G05D 1/0246; G06K 2009/4666; G06K 9/6262

(57) ABSTRACT

The invention relates to a deep-learning-based driving assistance system and method thereof. The system adopts a one-stage object detection neural network, and is applied to an embedded device for quickly calculating and determining a driving object information. The system comprises an image capture module, a feature extraction module, a semantic segmentation module, and a lane processing module, wherein the lane processing module further comprises a lane line binary sub-module, a lane line clustering sub-module, and a lane line fitting sub-module.

### CROSS-REFERENCE TO RELATED APPLICATION

This application claims the benefit of Taiwan Patent Application No. 109115647, filed on May 11, 2020, in the Taiwan Intellectual Property Office, the disclosure of which is entirely incorporated herein by reference.

### FIELD OF TECHNOLOGY

The invention relates to a deep-learning-based driving assistance system and method thereof, in particular configured to an embedded device accurately simulating lane lines to achieve the purpose of lane departure determining for avoiding the collision through deep-learning-based semantic segmentation and object detection.

### BACKGROUND

In recent years, the development of driving assistance technology has gradually matured. In addition, the cost of camera is cheap and its setting and calibration are relatively simple compared to other sensors, so detection of lane lines and objects in front of vehicles has gradually attracted attention. But the problem to be overcome is that the algorithm is more complicated and the amount of calculation is relatively large.

In practical applications, there is a technology obtaining the motion vector of the front vehicle in the image to achieve the purpose of detecting the front object. However, the feature extraction method used is prone to be affected by changes of light and shadow in the images or the scenery. There is also a technology using an optimized edge detection and the Hough transform to achieve the purpose of detecting the lane lines. However, the above technology can only detect a single lane, and the lane line in the image must be quite obvious, otherwise the detection effect will be greatly affected. Further, there is also a technology predicting where the car will appear in the image by using neural network in order to estimate the distance between the objects and the vehicles. The object-detecting neural network used by the above technology is Faster-RCNN of a two-stage neural network, but it has disadvantages of large amount of calculation and a slow calculating speed.

For the above reason, how to reduce the amount of calculation of the deep-learning neural network while increasing the accuracy of detection and prediction when implementing the driving assistance system is an important problem to be solved in the art.

### SUMMARY

Accordingly, an object of the invention is to provide a deep-learning-based driving assistance system and method thereof, which can process object detection in an image with semantic segmentation by using deep-learning-based neural network to achieve the purpose of identifying lane lines to avoid colliding with the front objects. According to an embodiment of the invention, an input image is extracted to obtain a plurality of feature data, and various information of lane lines are determined by semantic segmentation. Then, the lane lines are categorized and identified to fit the lane lines. Then, the fitted lane lines are referenced to determine a drivable lane cooperated with the object detection to achieve the purpose of driving assistance.

Compared with traditional techniques (such as linear fitting, motion vector prediction, radar detection, etc.), the method according to the embodiment of the invention has better accuracy and stability for various weather factors or object types.

Specifically, a deep-learning-based driving assistance system using a one-stage object-detecting neural network is provided and applied to an embedded device for quickly calculating and determining a driving object information. The deep-learning-based driving assistance system comprises an image capture module, a feature extraction module, a semantic segmentation module, and a lane processing module. The image capture module is used to capture a plurality of road images by using a fixed frequency. The feature extraction module is configured to construct a plurality of feature data of a plurality of road objects based on the road images. The semantic segmentation module is configured to extract a plurality of classified probability maps of the road objects based on the feature data. The lane processing module is configured to construct a plurality of lane line fitting maps and comprises a lane line binarization sub-module, a lane line grouping sub-module, and a lane line fitting sub-module. The lane line binarization sub-module is used for binarizing the classified probability maps based on a confidence level of the classified probability maps and constructing a plurality of binary response maps of a lane line, wherein the binary response maps are a plurality of lane points. The lane line grouping sub-module is configured to group the binary response maps into a plurality of lane line categories. The lane line fitting sub-module is used for fitting the lane line categories by a cubic curve and connecting the lane line categories after fitted to obtain the lane line fitting maps.

According to another embodiment of the invention, the feature extraction module further comprises an attention sub-module for improving accuracy of the feature data by an amplification constant.

According to still another embodiment of the invention, the lane processing module further comprises a lane post-processing sub-module and a lane departure determining sub-module. The lane post-processing sub-module is used for constructing a drivable lane section based on the lane line fitting maps. The lane departure determining sub-module is configured to determine whether a driving direction deviates according to the drivable lane section.

According to still another embodiment of the invention, the deep-learning-based driving assistance system further comprises an object detection module obtaining positions of the road objects based on the feature data, wherein the object detection module comprises a collision avoidance determining sub-module estimating a plurality of relative distances and executing a plurality of collision avoidance determination based on the drivable lane section and the positions of the road objects.

Additionally, a method of deep-learning-based driving assistance is also provided. The method uses a one-stage object-detecting neural network and is applied to an embedded device for quickly calculating and determining a driving object information. The method comprises the following steps. A plurality of road images are captured by using a fixed frequency. A plurality of feature data are extracted based on the road images to construct the feature data of a plurality of road objects. A plurality of classified probability maps of each the road objects are extracted based on the feature data. The classified probability maps are binarized based on a confidence level of the classified probability maps to construct a plurality of binary response maps of a lane line, wherein the binary response maps are a plurality of lane points. The binary response maps are grouped into a plurality of lane line categories. The lane line categories is fitted by a cubic curve and connected after fitted to obtain the lane line fitting maps.

According to another embodiment of the invention, the method further comprises improving accuracy of the feature data by providing an amplification constant of the feature data.

According to still another embodiment of the invention, the method further comprises constructing a drivable lane section based on the lane line fitting maps to determine whether a driving direction deviates according to the drivable lane section.

According to still another embodiment of the invention, the method further comprises obtaining positions of the road objects based on the feature data to estimate a plurality of relative distances and execute a plurality of collision avoidance determination based on the drivable lane section and the positions of the road objects.

To sum up, the embodiments of the invention use an image capturing device with two tasks (object detection and semantic segmentation) and are further merged into a network to calculate. The above two tasks share the same network. However, the prior art uses high-order equations to directly linearly fit lane lines; in comparison, the embodiments of the invention use high-order equations to fit the lane lines via lane line categories. At a certain level, the embodiments of the invention fit the lane lines by connection; therefore, compared with the prior art, the embodiments of the invention can significantly reduce the amount of calculation and save more cost.

### BRIEF DESCRIPTION OF THE DRAWINGS

FIG. 1 is a structural diagram of a deep-learning-based driving assistance system according to an embodiment of the invention.

FIG. 2 is a flowchart of a method of deep-learning-based driving assistance according to an embodiment of the invention.

FIG. 3 is a flowchart of fitting lane lines according to an embodiment of the invention.

FIG. 4 is a complete response flowchart of lane lines according to an embodiment of the invention.

FIG. 5 is a comparison diagram of fitted curve lane between an embodiment of the invention and the prior art.

FIG. 6 is a schematic diagram of object detection according to an embodiment of the invention.

### DETAILED DESCRIPTION

In order to understand the technical features, contents and advantages of some embodiments of the invention and effects thereof, the embodiments of the invention are accompanied by drawings and described in detail as follows. The used drawings are only for illustrative purposes to support the description, and may not be the real scale and precise configuration of the embodiments of the invention. Therefore, relationship between the scale and configuration of the drawings should not be interpreted as the scope of rights or limited the scope of rights to the actual implementation of the embodiments of the invention, which shall be described first here.

Accordingly, a deep-learning-based driving assistance system and method thereof are provided, which can process object detection in an image with semantic segmentation by using deep-learning-based neural network to achieve the purpose of identifying lane lines to avoid colliding with the front objects. According to an embodiment of the invention, an input image is extracted to obtain a plurality of feature data, and various information of lane lines are determined by semantic segmentation. Then, the lane lines are categorized and identified to fit the lane lines. Then, the fitted lane lines are referenced to determine a drivable lane cooperated with the object detection to achieve the purpose of driving assistance.

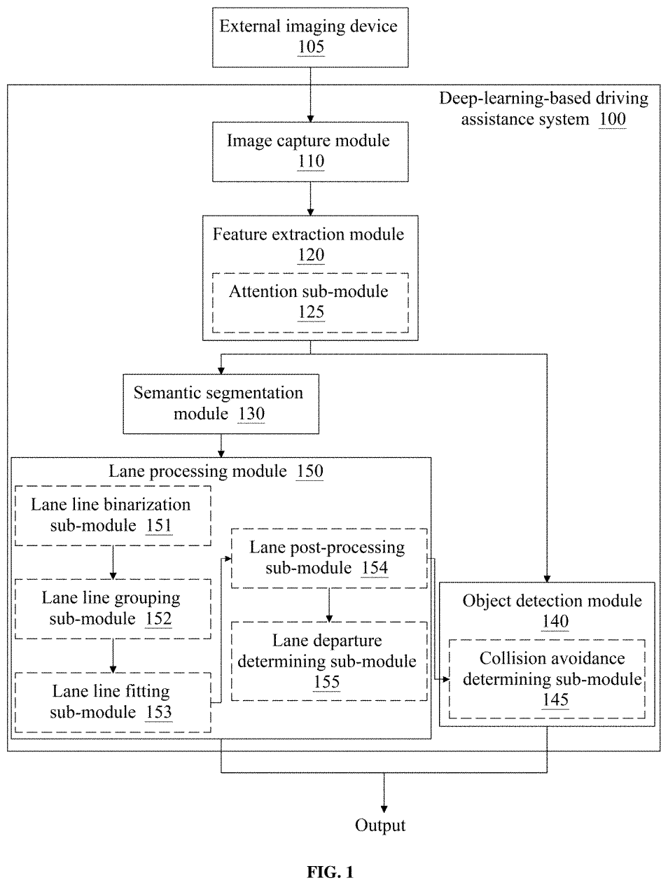

In order to more clearly describe the embodiments and technical features of the invention, please first refer to FIG. 1. FIG. 1 is a structural diagram of a deep-learning-based driving assistance system according to an embodiment of the invention. The deep-learning-based driving assistance system 100 is provided comprising an image capture module 110, a feature extraction module 120, a semantic segmentation module 130, and a lane processing module 150.

Moreover, the lane processing module 150 comprises a lane line binarization sub-module 151, a lane line grouping sub-module 152, and a lane line fitting sub-module 153.

The deep-learning-based driving assistance system 100 is further described as below. The image capture module 110 is used to capture a plurality of road images by using a fixed frequency after the road images are obtained by an external imaging device 105. The feature extraction module 120 is used to construct a plurality of feature data of a plurality of road objects based on the road images. The semantic segmentation module 130 is used to extract a plurality of classified probability maps of the road objects based on the feature data. The lane processing module 150 is used to construct a plurality of lane line fitting maps. The lane line binarization sub-module 151 is used for binarizing the classified probability maps based on a confidence level of the classified probability maps and constructing a plurality of binary response maps of a lane line, wherein the binary response maps are a plurality of lane points. The lane line grouping sub-module 152 is used to group the binary response maps into a plurality of lane line categories. The lane line fitting sub-module 153 is used for fitting the lane line categories by a cubic curve and connecting the lane line categories after fitted to obtain the lane line fitting maps.

According to another embodiment of the invention, the feature extraction module 120 further comprises an attention sub-module 125 providing an amplification constant to the feature data for improving accuracy of the feature data.

According to still another embodiment of the invention, the lane processing module 150 further comprises a lane post-processing sub-module 154 and a lane departure determining sub-module 155. The lane post-processing sub-module 154 is used for constructing a drivable lane section based on the lane line fitting maps. The lane departure determining sub-module 155 is used to determine whether a driving direction deviates or not according to the drivable lane section.

According to still another embodiment of the invention, the deep-learning-based driving assistance system 100 further comprises an object detection module 140. The object detection module 140 is used for obtaining positions of the road objects based on the feature data, wherein the object detection module 140 comprises a collision avoidance determining sub-module 145 estimating a plurality of relative distances and executing a plurality of collision avoidance determination based on the drivable lane section and the positions of the road objects.

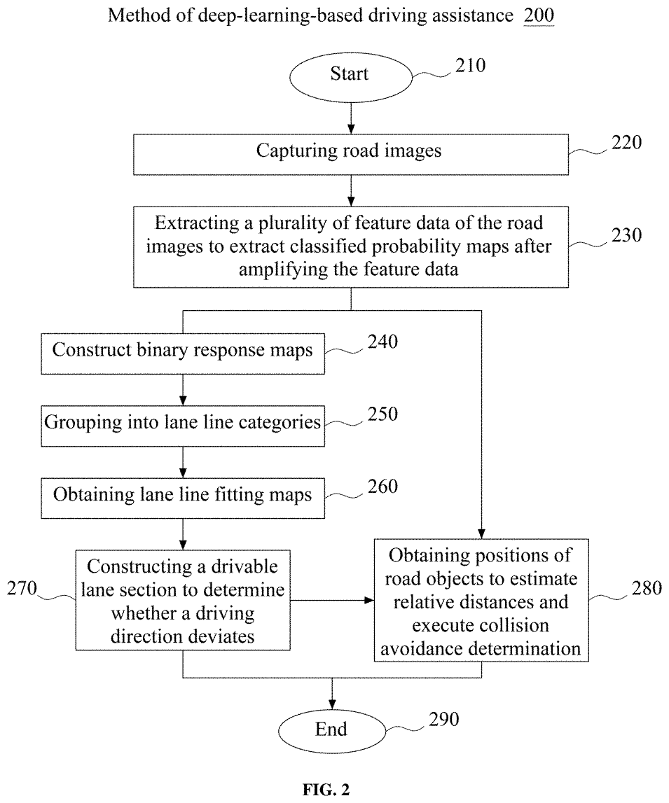

FIG. 2 is a flowchart of a method of deep-learning-based driving assistance according to an embodiment of the invention. The method 200 of deep-learning-based driving assistance starts from step 210 and further comprises the following steps.

First, in step 220, a plurality of road images are captured (for example, through the image capture module 110) by using a fixed frequency (such as every second, every minute, etc.), and the images are continuous images.

Subsequently, in step 230, a plurality of feature data of a plurality of road objects are extracted based on the road images (for example, through the feature extraction module 120), for then amplifying the feature data (for example, through the attention sub-module 125) and extracting a plurality of classified probability maps of the road objects based on the amplified feature data (for example, through the semantic segmentation module 130).

Subsequently, in step 240, the classified probability maps are based to further construct a plurality of binary response maps (for example, through the lane line binarization sub-module 151).

Subsequently, in step 250, the binary response maps are further grouped into a plurality of lane line categories (for example, through the lane line grouping sub-module 152).

Subsequently, in step 260, the lane line categories are fitted by a cubic curve to construct and obtain the lane line fitting maps (for example, through the lane line fitting sub-module 153).

Subsequently, in step 270, a drivable lane section are constructed based on the lane line fitting maps (for example, through the lane post-processing sub-module 154), and the drivable lane section is further used to determine whether a driving direction deviates (for example, through the lane departure determining sub-module 155).

Subsequently, in step 280, positions of the road objects are obtained based on the feature data to estimate a plurality of relative distances and execute a plurality of collision avoidance determination based on the drivable lane section and the positions of the road objects (for example, through the object detection module 140).

Subsequently, all the data are exported and the method 200 is finished in step 290.

A specific example is provided as below to further illustrate that the embodiments of invention have advantages of fast calculating speed with high accuracy.

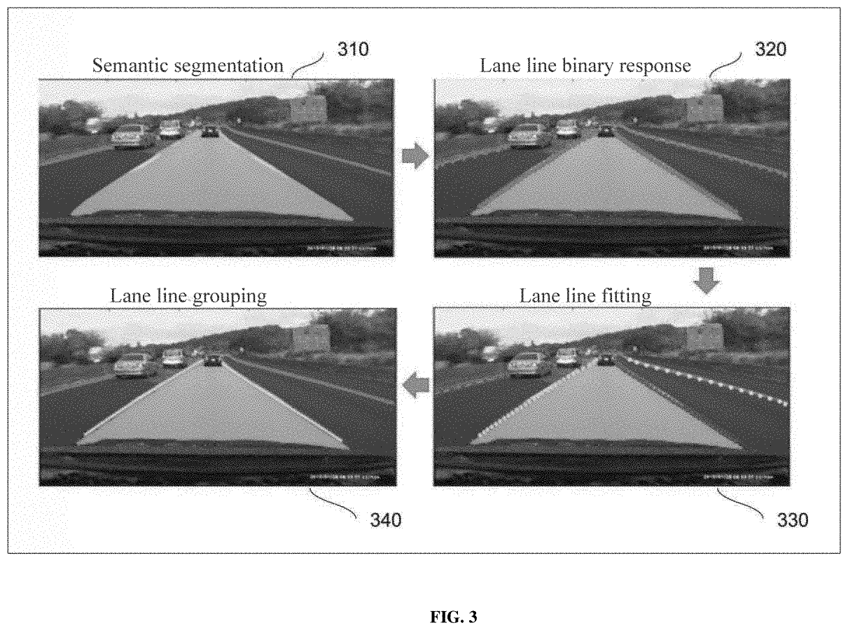

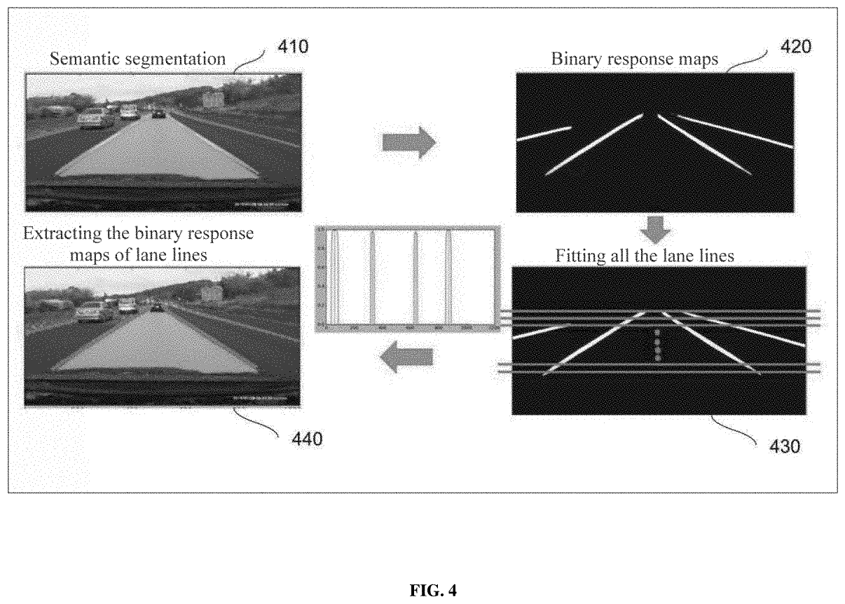

Please refer to FIGS. 3-4 at the same time. FIG. 3 is a flowchart of fitting lane lines according to an embodiment of the invention, and FIG. 4 is a complete response flowchart of lane lines according to an embodiment of the invention.

Steps 310 and 410 are the same, that is, both are specifically executed results after trained by, for example, the feature extraction module 120 and the semantic segmentation module 130. The feature extraction module 120 uses, for example, a lightly modified ResNet-10 network, and pre-trains its weights on an ImageNet dataset. The function of the ResNet-10 network is to extract image features, and describe the scene by using features like the shape, color, and material of objects that can be observed just as human eyes. Next, the semantic segmentation module 130 combines feature data from the feature extraction module 120 with a lane of BDD100K and its lane line data to perform semantic segmentation training. A lane and its lane line are referenced to mark the image during the training process, and the marked image is then used as a targeted image. The goal of the semantic segmentation network is to output the same image. The difference between the image and the marked image is used to calculate a differential value for updating a network parameter, so that the image exported from the semantic segmentation network next time can be much closer to the marked image.

Next, for the results of step 320, please refer to the steps 420-440 in FIG. 4 which are described in detail as below.

Step 420 is performed based on the result of semantic segmentation in step 410. The lane line category indicates whether it is a lane, a lane line or background. A pixel point has a decimal value ranging from 0 to 1. The lane line category indicates whether it is a lane, a lane line or background, which represents a confidence level of the prediction model for the pixel point, and the lane line category with the highest confidence level is taken as a final category. Subsequently, the pixel point grouped into the “non-lane line” category is set to 0, and the pixel point grouped into the “lane line” category is set to 1, so that the binarized response map shown in step 420 may be obtained. As shown in the figure of step 430, a center pixel point, that is, in the middle of a from-left-to-right horizontal line, among a group consisting of the pixel points of the lane lines is taken as a representative. Subsequently, as shown in step 440, a lane point map is obtained, which is a complete lane line response.

Next, in step 330, after performed as in step 440 and the complete lane line response is obtained, a grouping algorithm is then performed. The grouping algorithm calculates and determines which lane-point lists the point should be grouped into. If no target is found, a lane-point list will be added. After finishing the image in this way, an image containing clean lane points as shown in step 330 is obtained. In addition, the grouping algorithm is further listed in detail as below.

Algorithm 1. Clustering Method

| | |
|---|---|
| 1: | All_clusters = [ ] |
| 2: | y = height −1 |
| 3: | loop(y > y_limit); |

| | |
|---|---|
| 4: | loop point in local_maximum_points: |

| | |
|---|---|
| 5: | if (All_clusters is empty): |
| 6: | create_new_cluster(All_clusters, point) |
| 7: | end if |
| 8: | cluster_index, min_distance, angle = |
| | get_min_distance_and_angle(All_clusters, point) |
| 9: | if (min_distance < min_distance_threshold and angle < |
| | angle_threshold): |

| | |
|---|---|
| 10: | add_to_cluster(clusters , point, cluster_index) |

| | |
|---|---|
| 11: | else: |

| | |
|---|---|
| 12: | create_new_cluster(All_clusters, point) |

| | |
|---|---|
| 13: | end if |

| | |
|---|---|
| 14: | y −= update_interval |
| 15: | end loop |

| | |
|---|---|
| 16: | end loop |
| 17: | loop cluster in All_clusters: |

| | |
|---|---|
| 18: | All_clusters = Majority_Vote(All_clusters) |

As shown in the above algorithm, the grouping algorithm mainly calculates the absolute distance between a point coordinate and a last point coordinate of the lane point list. If the distance is less than a threshold we set, they are grouped into the same category. There are also restrictions on the angle. For example, when the angle changes too much, it is grouped into another category to filter out the lane lines with abnormal curving.

Next, in step 340, the lane point list obtained from the grouping algorithm may be subsequently calculated by an existing polynomial fitting algorithm to further obtain the lane line fitting map.

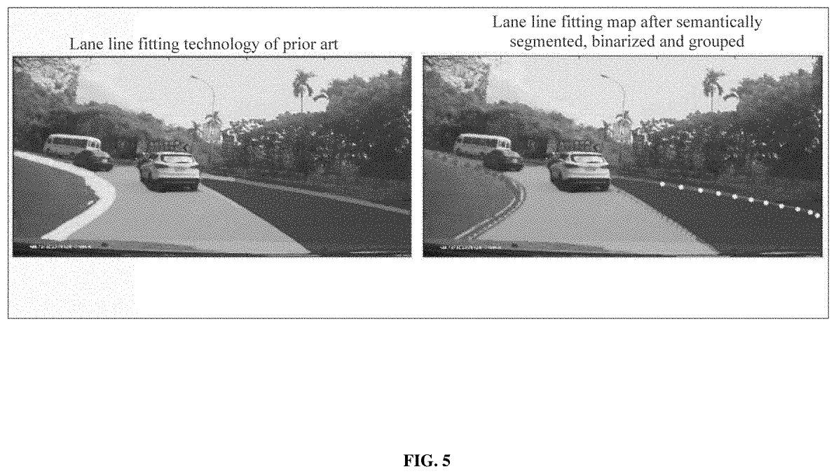

Regarding the step 340, please further refer to FIG. 5. FIG. 5 is a comparison diagram of fitted curve lane between an embodiment of the invention and the prior art. A curve of y=ax³+bx²+cx+d is used by the prior art for the lane line fitting algorithm. However, the curve is likely to fail to fit when the lane line is curved. In the embodiment of the invention, when the situation occurs, the program will automatically try to use a curve of x=ay³+by²+cy+d to fit and the problem may thus be solved.

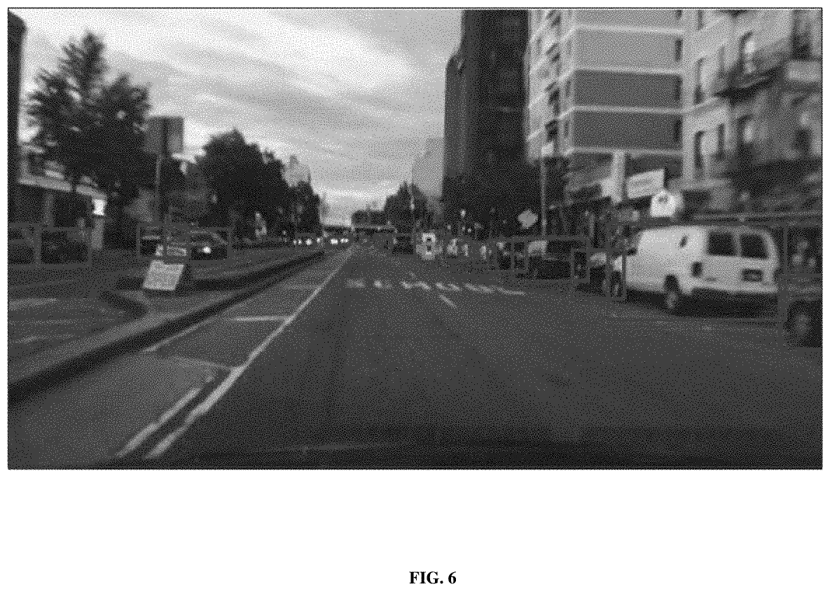

FIG. 6 is a schematic diagram of object detection according to an embodiment of the invention. The feature extraction module 120 uses, for example, a lightly modified ResNet-10 network, and pre-trains its weights on an ImageNet dataset. The object detection module 140 combines feature data from the feature extraction module 120 with a person, a car, a motorcycle, etc. of BDD100K to perform object detection network training. An array of object frame is marked and taken as a targeted object frame during the training process. The goal of the object detection network is to output the same object frame with the same position. The difference between the object frame and the targeted object frame is used to calculate a differential value for updating a network parameter, so that the object frame exported from the object detection network next time can be much closer to the targeted object frame.

In addition, in the embodiment of the invention, the semantic segmentation module 130 and the object detection module 140 will alternately train until a final output and the targeted are close enough and no longer significantly decrease.

Some embodiments of the invention are disclosed herein. However, any person skilled in the art should understand that the embodiments are only used to describe the invention and are not intended to limit the scope of the patent rights claimed by the invention. Any changes or substitutions equivalent to the embodiments of the invention should be interpreted as being covered within the spirit or scope of the invention. Therefore, the protection scope of the invention shall be subject to the scope defined by the claims as follows.

What is claimed is:

1. A deep-learning-based driving assistance system using a one-stage object-detecting neural network and applied to an embedded device for quickly calculating and determining a driving object information comprising:
an image capture module to capture a plurality of road images by using a fixed frequency;
a feature extraction module configured to construct a plurality of feature data of a plurality of road objects based on the road images;
a semantic segmentation module configured to extract a plurality of classified probability maps of the road objects based on the feature data; and
a lane processing module configured to construct a plurality of lane line fitting maps comprising:
a lane line binarization sub-module for binarizing the classified probability maps based on a confidence level of the classified probability maps and constructing a plurality of binary response maps of a lane line, wherein the binary response maps are a plurality of lane points;
a lane line grouping sub-module configured to group the binary response maps into a plurality of lane line categories; and
a lane line fitting sub-module for fitting the lane line categories by a cubic curve and connecting the lane line categories after fitted to obtain the lane line fitting maps.

2. The deep-learning-based driving assistance system of claim 1, wherein the feature extraction module further comprises an attention sub-module for improving accuracy of the feature data by an amplification constant.

3. The deep-learning-based driving assistance system of claim 1, wherein the lane processing module further comprises:
a lane post-processing sub-module for constructing a drivable lane section based on the lane line fitting maps; and
a lane departure determining sub-module configured to determine whether a driving direction deviates according to the drivable lane section.

4. The deep-learning-based driving assistance system of claim 1, further comprising an object detection module obtaining positions of the road objects based on the feature data, wherein the object detection module comprises a collision avoidance determining sub-module estimating a plurality of relative distances and executing a plurality of collision avoidance determination based on the drivable lane section and the positions of the road objects.

5. A method of deep-learning-based driving assistance using a one-stage object-detecting neural network and applied to an embedded device for quickly calculating and determining a driving object information comprising:
capturing a plurality of road images by using a fixed frequency;
extracting a plurality of feature data based on the road images to construct the feature data of a plurality of road objects;
extracting a plurality of classified probability maps of each the road objects based on the feature data;
binarizing the classified probability maps based on a confidence level of the classified probability maps to construct a plurality of binary response maps of a lane line, wherein the binary response maps are a plurality of lane points;
grouping the binary response maps into a plurality of lane line categories; and
fitting the lane line categories by a cubic curve and connecting the lane line categories after fitted to obtain the lane line fitting maps.

6. The method of deep-learning-based driving assistance of claim 5, further comprising improving accuracy of the feature data by providing an amplification constant of the feature data.

7. The method of deep-learning-based driving assistance of claim 5, further comprising constructing a drivable lane section based on the lane line fitting maps to determine whether a driving direction deviates according to the drivable lane section.

8. The method of deep-learning-based driving assistance of claim 5, further comprising obtaining positions of the road objects based on the feature data to estimate a plurality of relative distances and execute a plurality of collision avoidance determination based on the drivable lane section and the positions of the road objects.
